(19) United States
(12) Patent Application Publication
(10) Pub. No.: US 2026/0267713 A1
(43) Pub. Date: Sep. 10, 2026

(54) Enhanced Fairness Using Wrapper Functions

(71) Applicant: Oracle International Corporation, Redwood City, CA (US)

(72) Inventor: David Dice, Foxboro, MA (US)

(21) Appl. No.: 19/531,461

(22) Filed: Feb. 5, 2026

Related U.S. Application Data
(60) Provisional application No. 63/758,242, filed on Feb. 13, 2025.

(51) Int. Cl. G06F 9/52

(52) U.S. Cl. CPC G06F 9/52

(57) ABSTRACT

A computer comprising one or more processors and memory may implement multiple threads that perform synchronization operations using an unfair synchronization primitive. To enhance fairness, the threads may access the synchronization primitive through a fairness enhancing wrapper. A threshold number of threads may be allowed access to the synchronization primitive, then upon the threshold number being met, access by additional threads may be blocked. Once a number of threads allowed access to the synchronization primitive returns to a zero number of threads, access by additional threads to the synchronization primitive may be re-enabled.

### PRIORITY CLAIM

This application claims benefit of priority to U.S. Provisional Application Ser. No. 63/758,242, titled “Enhanced Fairness Using Wrapper Functions,” filed Feb. 13, 2025, and which is hereby incorporated herein by reference in its entirety.

### BACKGROUND

### Field of the Disclosure

This disclosure relates generally to concurrent programming, and more particularly to systems and methods for performing concurrent synchronization.

### Description of the Related Art

Modern computer systems conventionally include the ability to perform multiple threads of execution simultaneously, thus giving rise to the need to synchronize threads for access to shared data structures. Among these synchronization mechanisms are locks, a widely used and foundational synchronization and coordination construct used for shared memory multithreaded programming. Many implementations of locks have been realized with many different characteristics and applications. Among them is the classic test-and-set lock which is simple and exhibits low latency absent contention, has low handover latency under light contention but may also admit long-term unfairness under load. Such unfairness may result in some threads starving while other threads make progress, resulting in throughput disparities. This effect can persist over long periods. In turn, this can result in unpredictable performance, failure to adhere to service-level agreements (SLAs) and introduce potential vulnerabilities to denial-of-service attacks.

### SUMMARY

Methods, techniques and systems for implementing multiple threads that perform synchronization operations using an unfair synchronization primitive such as test-and-set locks. To enhance fairness, the threads may access the synchronization primitive through a simple, efficient, fairness-enhancing synchronization construct that preserves desirable properties of the existing synchronization primitive. A threshold number of threads may be allowed access to the synchronization primitive, then upon the threshold number being met, access by additional threads may be blocked. Once a number of threads allowed access to the synchronization primitive returns to a zero number of threads, access by additional threads to the synchronization primitive may be re-enabled.

### BRIEF DESCRIPTION OF THE DRAWINGS

FIG. 1 is a block diagram illustrating a system implementing a multithreaded application execution environment performing synchronizations through use of a fairness-enhancing wrapper, according to at least one embodiment.

FIG. 2 is a diagram illustrating a fairness-enhancing wrapper function according to at least one embodiment.

FIGS. 3A, 3B and 3C are a diagram illustrating a semaphore for a scalable fairness-enhancing wrapper function according to at least one embodiment.

FIG. 4 is a flow chart illustrating a wrapper function providing fairness for entering a synchronization primitive, according to at least one embodiment.

FIG. 5 is a flow chart illustrating a wrapper function providing fairness for leaving a synchronization primitive, according to at least one embodiment.

FIG. 6A is a graph illustrating throughput and fairness of a reciprocating lock accessed through a fairness-enhancing wrapper function according to at least one embodiment.

FIG. 6B is a graph illustrating throughput and fairness of a ticket lock accessed through a fairness-enhancing wrapper function according to at least one embodiment.

FIG. 6C is a graph illustrating throughput and fairness of a Last-In-First-Out lock accessed through a fairness-enhancing wrapper function according to at least one embodiment.

FIG. 6D is a graph illustrating throughput and fairness of an MCS lock accessed through a fairness-enhancing wrapper function according to at least one embodiment.

FIG. 6E is a graph illustrating throughput and fairness of a test-and-set lock accessed through a fairness-enhancing wrapper function according to at least one embodiment.

FIG. 7 is a block diagram illustrating one embodiment of a computing system that is configured to implement ticket-based semaphores, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Modern computer systems conventionally include the ability to perform multiple threads of execution simultaneously, thus giving rise to the need to synchronize threads for access to shared data structures. Among these synchronization mechanisms are locks, a widely used and foundational synchronization and coordination construct used for shared memory multithreaded programming. Many implementations of locks have been realized with many different characteristics and applications. Among them is the classic test-and-set lock which is simple and exhibits low latency absent contention, has low handover latency under light contention but may also admit long-term unfairness. Such unfairness may result in some threads starving while other threads make progress, resulting in throughput disparities. This effect can persist over long periods. In turn, this can result in unpredictable performance, failure to adhere to service-level agreements (SLAs) and introduce potential vulnerabilities to denial-of-service attacks.

A computer comprising one or more processors and memory may implement multiple threads that perform synchronization operations using an unfair synchronization primitive such as test-and-set locks. To enhance fairness, the threads may access the synchronization primitive through a simple, efficient, fairness-enhancing synchronization construct that preserves desirable properties of the existing synchronization primitive. A threshold number of threads may be allowed access to the synchronization primitive, then upon the threshold number being met, access by additional threads may be blocked. Once a number of threads allowed access to the synchronization primitive returns to a minimum threshold or zero number of threads, access by additional threads to the synchronization primitive may be re-enabled.

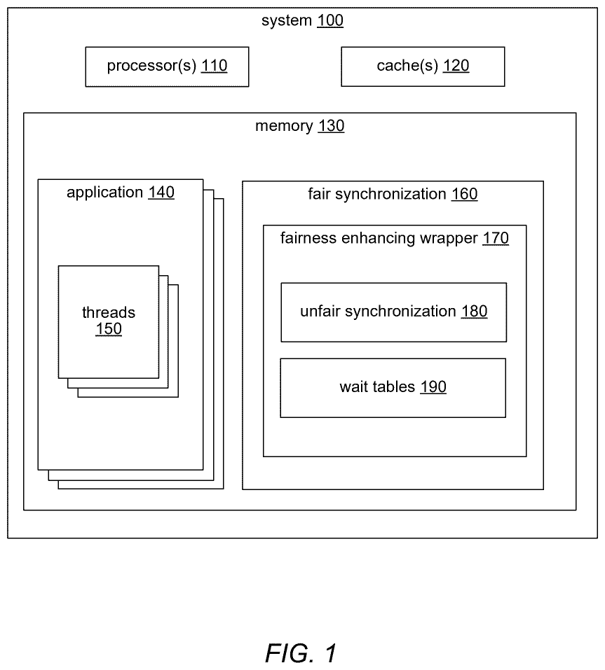

FIG. 1 is a block diagram illustrating a system implementing a multithreaded application execution environment performing synchronizations through use of a fairness-enhancing wrapper, according to at least one embodiment. System 100 includes one or more processors 110 capable executing multiple parallel threads of execution coupled through one or more caches 120 to a memory 130 that includes an application 140. Application 140 may include multiple executing threads 150 that access shared resources using synchronization operations such as provided by fair synchronization 160. While FIG. 1 shows a single application with three executing threads, this example is not intended to be limiting and any number of applications with any number of threads sharing any number of resources using any number of fair and unfair synchronization interfaces may be envisioned. Furthermore, in at least one embodiment, fair synchronization 160 may be provided as part of a library external to an application and shared among multiple applications 140 while in other embodiments fair synchronization 160 may be included within am application 140 itself. It should be understood that fair synchronization 160 may be provided in a number of ways and the examples above are not intended to be limiting.

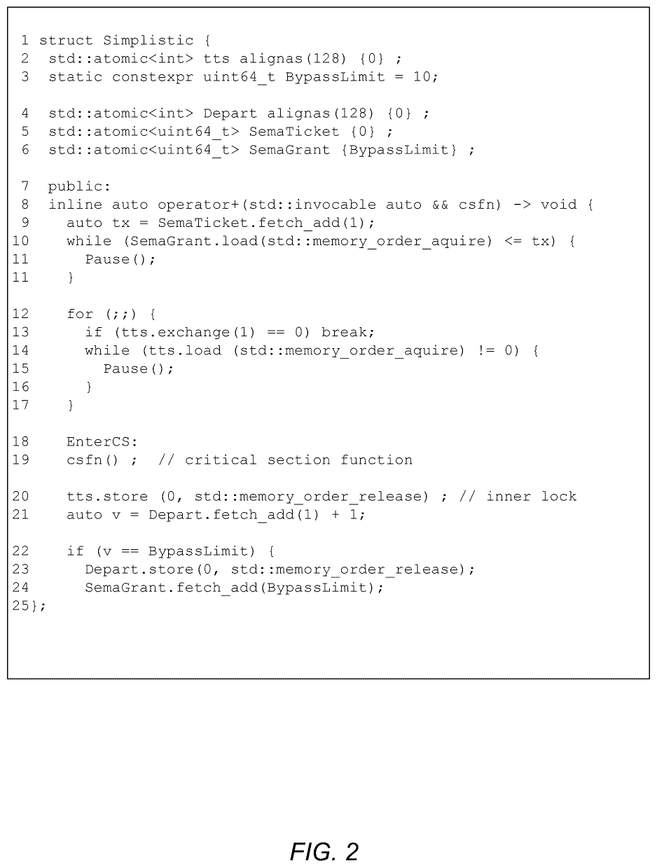

In at least one embodiment, fair synchronization 160 may be implemented using unfair synchronization 180 through use of fairness enhancing wrapper 170 which may provide a simple, efficient, fairness enhancement that preserves desirable properties of the unfair synchronization 180. Various embodiments of fairness enhancing wrapper 170 are discussed below in FIGS. 2-6. In at least one embodiment, fairness enhancing wrapper 170 may employ wait tables 190 to enhance fairness, where wait tables 190 may be configured according to fairness constraints such a number of processors 110 and configuration of cache(s) 120.

FIG. 2 is a diagram illustrating a fairness-enhancing wrapper function according to at least one embodiment in the form of pseudo-code similar to modern C++. In the embodiment, the underlying unfair synchronization operation, such as unfair synchronization 180 of FIG. 1, is a test-and-set (TTS) lock represented as a tts object such as in lines 2, 13, 14 and 20. For brevity, FIG. 2 expresses a critical section as a C++ lambda expression csfn( ) (lines 8 and 19). Non-escaping lambdas are efficient and add no particular runtime overhead.

In at least one embodiment, line 2 declares a test-and-set lock, tts, while lines 4-6 declare a wrapper function to enhance fairness. This wrapper function may be considered analogous to a capacitor as it provides an admittance behavior similar to that of a capacitor undergoing cyclical charges and discharges. As used herein, the term capacitor refers to a wrapper function that provides this fairness-enhancing behavior.

In at least one embodiment, a capacitor primitive may expose arrive and depart operations. A first number, B, of threads—where B is a tunable parameter—that call the arrive function may pass through the capacitor without blocking, where in at least one embodiment, after B threads have passed through an arrive function, the capacitor may shift to closed or blocked state where threads calling arrive will block in the capacitor. The capacitor may then remain closed until all B threads in a current group or platoon have called depart, in which case the capacitor may re-open to admit another platoon of B threads. If threads are waiting in arrive, then the next platoon to be released may consist of the least recently arrived threads. In at least one embodiment, capacitors may be implemented by means of semaphores coupled with one or more additional variables that track thread arrivals, departures and so forth.

In at least one embodiment, admission order provided by a semaphore may be First-In-First-Out (FIFO) or first-in-first-enabled. In at least one embodiment, a capacitor may construct a composite lock as follows. An existing lock, such as provided in unfair synchronization 180 of FIG. 1, which may be called an interior lock or inner lock, is paired with a private capacitor instance. Thus, the capacitor “wraps” that lock. To acquire the composite lock, a thread may invoke an arrive function on the capacitor, then acquire the inner lock, execute the critical section, release the inner lock, and finally invoke a depart function on the capacitor.

In at least one embodiment, a composite lock may provide a strong bounded bypass property which confers both long-term fairness and avoids short-term starvation. For example, a thread T1 arrives to acquire the composite lock L. At most only B-1 other threads that arrived after T1 can acquire L before T1 gains ownership of L, resulting in B-1-bounded-bypass property.

In at least one embodiment, lines 5 and 6 declare a simple, non-scalable semaphore implemented as a variation on a classic ticket lock. The semaphore may be initialized with (BypassLimit) credits at line 6. In at least one embodiment, a Depart variable may tally the number of threads that have called the capacitor's depart primitive within a current platoon, allowing a means to determine when a platoon has completed and a new platoon should be enabled

In at least one embodiment, lines 9-11 may acquire the semaphore, waiting if necessary. Once acquired, a thread is part of a current platoon and proceeds to acquire the inner, unfair lock at lines 12-17. Having acquired an inner lock, in at least one embodiment the thread may enter and execute a critical section at line 19, then release the inner lock at line 20. Finally, a thread may execute a depart operation on the semaphore, at lines 20-24. At line 21 the thread may first atomically increment a Departed field. When that value reaches BypassLimit, the capacitor must be in closed state. As only one thread can be the final thread to cause the tally to reach BypassLimit, and the capacitor is closed, no concurrency is possible. The thread may then reset Departed to 0 and enable the next platoon at line 24, potentially waking up to BypassLimit threads.

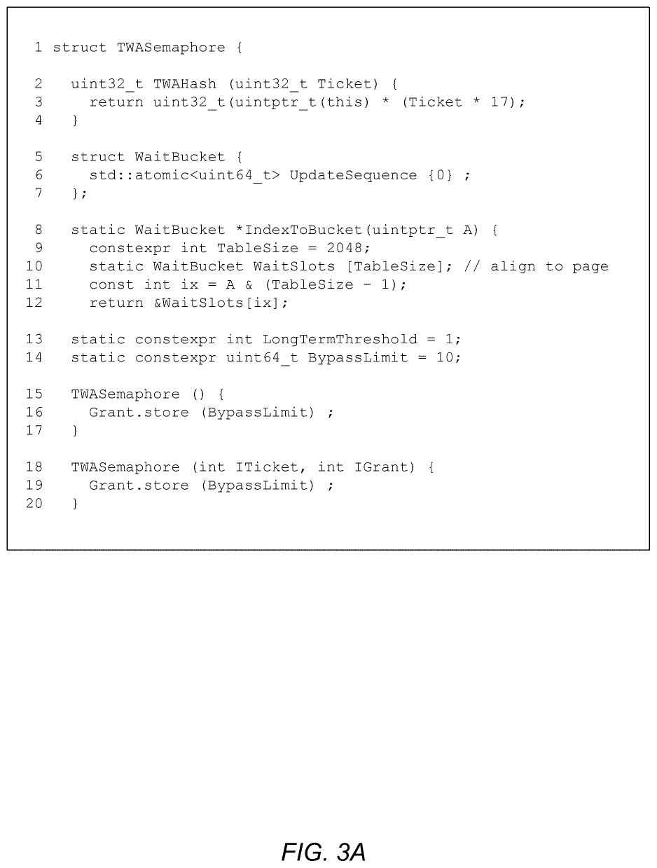

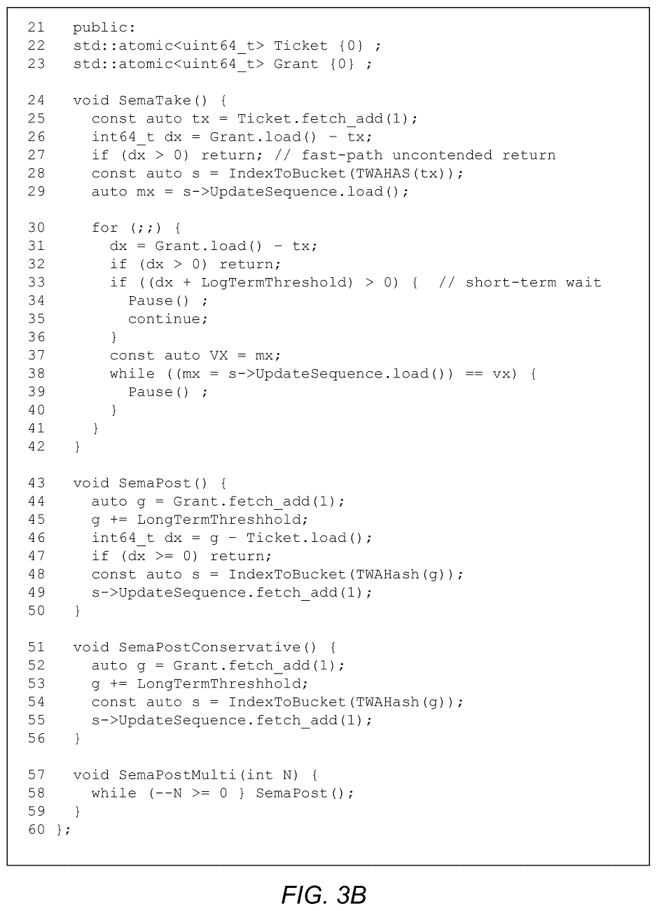

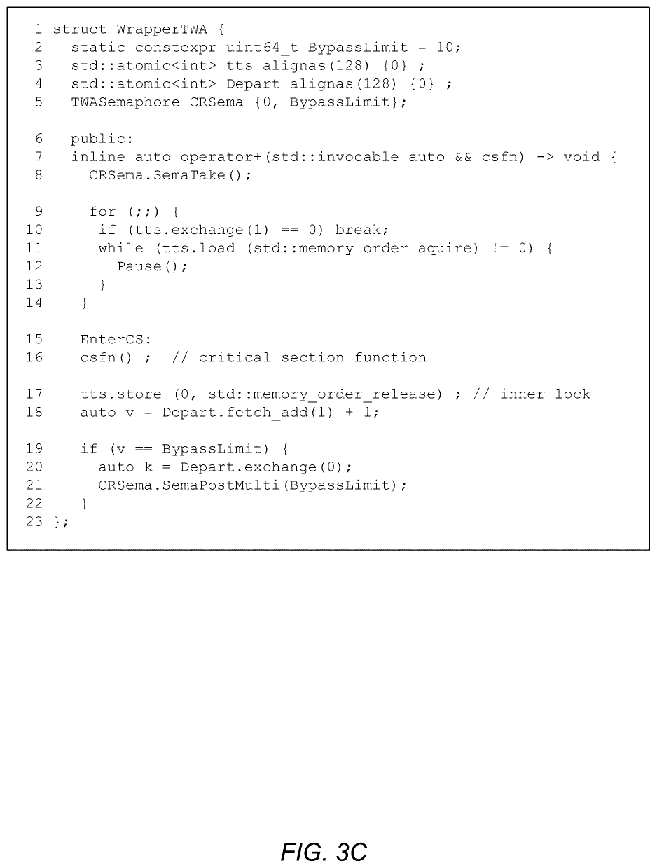

FIGS. 3A, 3B and 3C collectively provide a diagram illustrating a semaphore for a scalable fairness-enhancing wrapper function according to at least one embodiment in the form of pseudo-code similar to modern C++. In the embodiment, the underlying unfair synchronization operation, such as unfair synchronization 180 of FIG. 1, is a test-and-set (TTS) lock represented as a tts object such as in lines 3, 10, 11, 13 and 17 of FIG. 3C. For brevity, FIG. 3C expresses a critical section as a C++ lambda expression csfn( ) (line 16). Non-escaping lambdas are efficient and add no particular runtime overhead.

In at least one embodiment, FIG. 3C line 3 declares a test-and-set lock, tts, while lines 4-7 declare a wrapper function to enhance fairness. This wrapper function may be considered analogous to a capacitor as it provides an admittance behavior similar to that of a capacitor undergoing cyclical charges and discharges. As used herein, the term capacitor refers to a wrapper function that provides this fairness-enhancing behavior.

In at least one embodiment, a capacitor primitive may expose arrive and depart operations. A first number, B, of threads—where B is a tunable parameter—that call the arrive function may pass through the capacitor without blocking, where in at least one embodiment, after B threads have passed through an arrive function, the capacitor may shift to closed or blocked state where threads calling arrive will block in the capacitor. The capacitor may then remain closed until all B threads in a current group or platoon have called depart, in which case the capacitor may re-open to admit another platoon of B threads. If threads are waiting in arrive, then the next platoon to be released may consist of the least recently arrived threads. In at least one embodiment, capacitors may be implemented by means of semaphores coupled with one or more additional variables that track thread arrivals, departures and so forth.

In at least one embodiment, admission order provided by a semaphore may be First-In-First-Out (FIFO) or first-in-first-enabled. In at least one embodiment, a capacitor may construct a composite lock as follows. An existing lock, such as provided in unfair synchronization 180 of FIG. 1, which may be called an interior lock or inner lock, is paired with a private capacitor instance. Thus, a capacitor “wraps” that lock. To acquire the composite lock, a thread may invoke an arrive function on the capacitor, then acquire the inner lock, execute the critical section, release the inner lock, and finally invoke a depart function on the capacitor.

In at least one embodiment, a composite lock may provide a strong bounded bypass property which confers both long-term fairness and avoids short-term starvation. For example, a thread T1 arrives to acquire the composite lock L. At most only B-1 other threads that arrived after T1 can acquire L before T1 gains ownership of L, resulting in B-1-bounded-bypass property.

In at least one embodiment, FIG. 3C line 5 instantiates a semaphore shown in FIGS. 3A and 3B. The semaphore may be initialized with (BypassLimit) credits. In at least one embodiment, a Depart variable may tally the number of threads that have called the capacitor's depart primitive within a current platoon, allowing a means to determine when a platoon has completed and a new platoon should be enabled

In at least one embodiment, FIG. 3C line 8 may acquire the semaphore, waiting if necessary. Once acquired, a thread is part of a current platoon and proceeds to acquire the inner, unfair lock at FIG. 3C lines 9-14. Having acquired an inner lock, in at least one embodiment the thread may enter and execute a critical section at FIG. 3C line 16, then release the inner lock at FIG. 3C line 17. Finally, a thread may execute a depart operation on the semaphore, at FIG. 3C lines 18-22. At FIG. 3C line 18 the thread may first atomically increment a Departed field. When that value reaches BypassLimit, the capacitor must be in closed state. As only one thread can be the final thread to cause the tally to reach BypassLimit, and the capacitor is closed, no concurrency is possible. The thread may then reset Departed to 0 and enable the next platoon at FIG. 3C line 20, potentially waking up to BypassLimit threads.

FIGS. 3A and 3B provide a semaphore used by the wrapper function of FIG. 3C, in at least one embodiment. This semaphore may provide wait-free, constant-time put and take fast-path operations without a need to park and unpark, in at least one embodiment. The semaphore may provide FIFO admission order and is compact, providing semi-local waiting via a local waiting array. In at least one embodiment, a local waiting array, such as the wait table 190 of FIG. 1, is declared in FIG. 3A line 10, where the array is of a TableSize declared in FIG. 3A line 9. While TableSize is merely declared as a constant, it should be understood that the size may be determined in a number of different ways in various embodiments. For example, TableSize may be configured according to a number of processors such as processors 110 of FIG. 1, or a configuration of caches such as caches 120 of FIG. 1. These examples are not intended to be limiting and other TableSize considerations may be employed.

In at least one embodiment, a ticket-aware hash function may be declared in FIG. 3A lines 2-4. This hash function may maps lock address and ticket value pairs to indices, or buckets, in the long-term waiting array. In at least one embodiment, as a ticket advances, an index computed by the hash function may walk through a range of possible bucket indices before repeating. To reduce coherence traffic and false sharing, adjacent (or numerically proximal) ticket values should map to indices in the table that reside on different cache lines. A set of waiting threads may have adjacent ticket values but may be well-dispersed over buckets to avoid false sharing or even true collisions. In at least one embodiment, only one thread may wait on a given bucket at a given time.

In at least one embodiment, inter-lock parallel ticket entrainment, where different locks or semaphores might move in unison, may inadvertently generate streams of ticket values that continue to collide in the array. In at least one embodiment, supplementary hashes (not shown) may mitigate this issue. In at least one embodiment, multiplying a lock address component by a Ticket component may also be employed.

In at least one embodiment, multiplication constants in the hash function may be coprime with one other and the length of the array, but also sufficiently large that adjacent ticket values map to indices that map to different cache lines. This may provide an optimal “tickets marching through the array” behavior.

In at least one embodiment, incoming ticket values may be preconditioned to group thread with numerically adjacent ticket values into pairs. In at least one embodiment, this may provide a pipelines early wakeup effect. In at least one embodiment, an incoming ticket value may be a composite of bit fields, where a portion of a ticket value may identify a logical sub-page in a waiting array while another portion may undergo a hash operation. A stream of sequential ticket values may then localize within a sub-page before advancing to a next sub-page. In at least one embodiment, this approach may minimize page transitions for given streams of ticket values, reducing TLB pressure on caches.

In at least one embodiment, semaphore allocation is shown in FIG. 3B lines 43-59. In at least one embodiment, where a short term wait is implemented in lines 33-36 and a long term wait using the waiting array is shown in lines 37-40. In at least one embodiment, semaphore release is shown in FIG. 3B lines 24-42. In at least one embodiment, if a difference between an observed ticket value and a current ticket value is less than a long term threshold, as shown in lines 46-47, then it may be assumed that there are no long term waiters allowing long-term notification to be skipped. If a thread calls SemaPost, creating a race condition, then unnecessary notifications may be performed, however correctness is ensured.

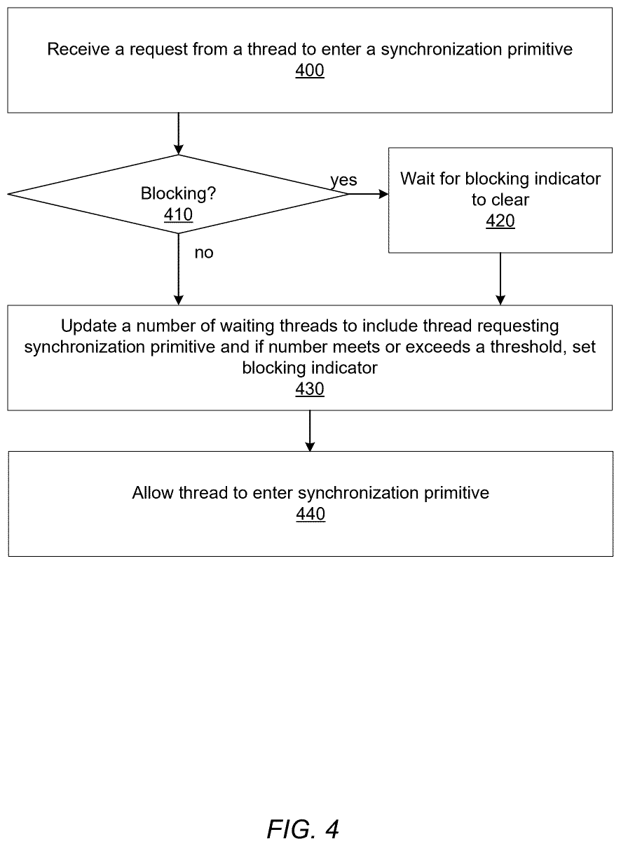

FIG. 4 is a flow chart illustrating a wrapper function providing fairness for entering a synchronization primitive, according to at least one embodiment. In at least one embodiment, the process begins at 400 when a thread, such as thread 150 of FIG. 1, requests to enter a synchronization primitive, such as unfair synchronization 180 of FIG. 1 or tts functions of FIGS. 2 and 3C. In at least one embodiment, this request may be processed by a wrapper function of the synchronization primitive, such as fairness enhancing wrapper 160 of FIG. 1. Then, as shown in 410, a blocking indicator may be checked to determine whether synchronization access is in a cleared state or a blocked state. In at least one embodiment, this indicator may be maintained using one or more state enumerations while in other embodiments the indicator may be maintained in the form of one or more allowed thread counts. It should be understood that these are merely examples and any manner of maintaining a state indicator may be envisioned.

If the indicator indicates a clear or non-blocking state, as indicated by a negative exit from 410, then the process may advance to 430. If the indicator indicates a blocked state, as indicated by a positive exit from 410, then the process may advance to 420 where the thread may wait for the blocking indicator to indicate a clear or non-blocking state. Once the indicator is set to a clear or non-blocking state, the process may advance to 430.

In at least one embodiment, as shown in 430 a number of waiting threads may then be updated to include the calling thread as having entered the requested synchronization primitive and if a number of threads entered the primitive meets or exceeds a threshold, the blocking indicator may be set to a blocked state. Once the number of waiting threads is updated, the thread may enter the synchronization primitive, as shown in 440.

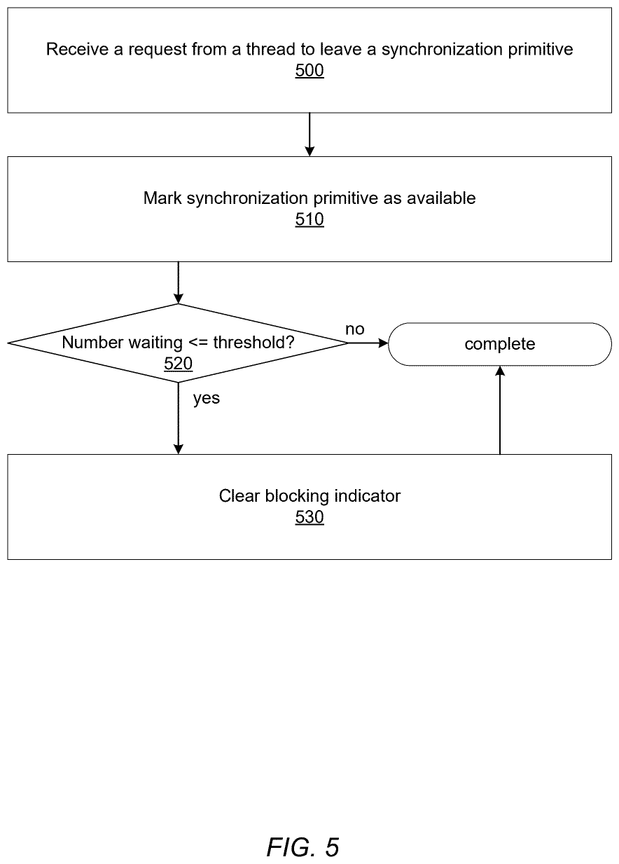

FIG. 5 is a flow chart illustrating a wrapper function providing fairness for leaving a synchronization primitive, according to at least one embodiment. In at least one embodiment, the process begins at 500 when a thread, such as thread 150 of FIG. 1, requests to leave a synchronization primitive, such as unfair synchronization 180 of FIG. 1 or tts functions of FIGS. 2 and 3C. In at least one embodiment, this request may be processed by a wrapper function of the synchronization primitive, such as fairness enhancing wrapper 160 of FIG. 1. Then, as shown in 510, control of the synchronization primitive may be updated to indicate that the thread has released control and synchronization may advance to another waiting thread. Then, as shown in 520, in at least one embodiment a number of waiting threads may be checked to determine whether the number waiting less than or equal to a minimum threshold, such as zero, of waiting threads.

If the number of waiting threads is less than or equal to the minimum threshold, as indicated by a positive exit from 520, then the process may advance to 530. If the number of waiting threads is greater than the minimum threshold, as indicated by a negative exit from 520, then the process is complete.

In at least one embodiment, as shown in 530 a blocking indicator may be set to a clear or non-blocking state. In at least one embodiment, this process may include advancing a current group or platoon to efficiently managing caching performance. In at least one embodiment, advancing a current group may further include selecting a new index or bucket of a wait array for a newly selected group. Once the blocking indicator indicates a non-blocking state, the process is complete.

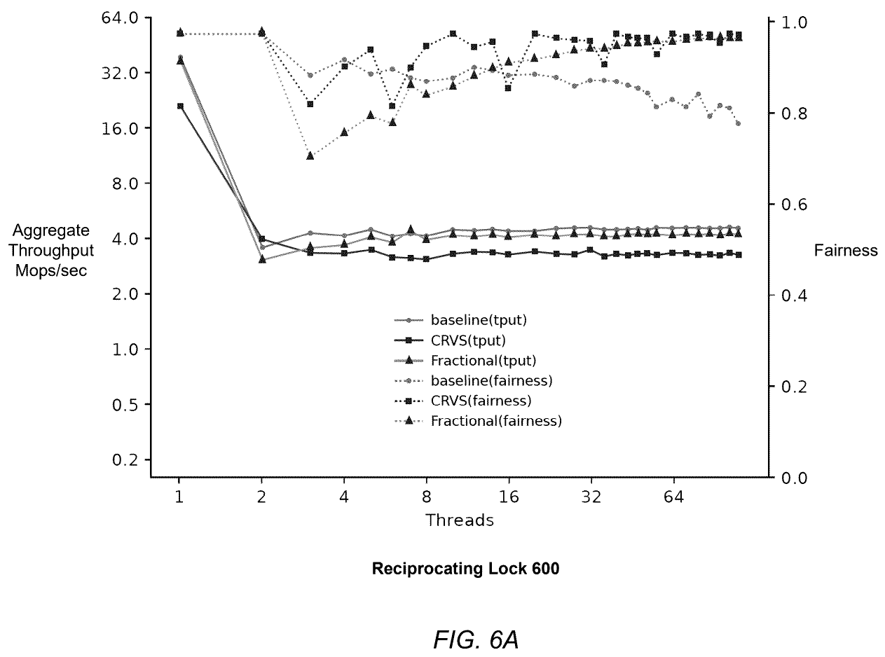

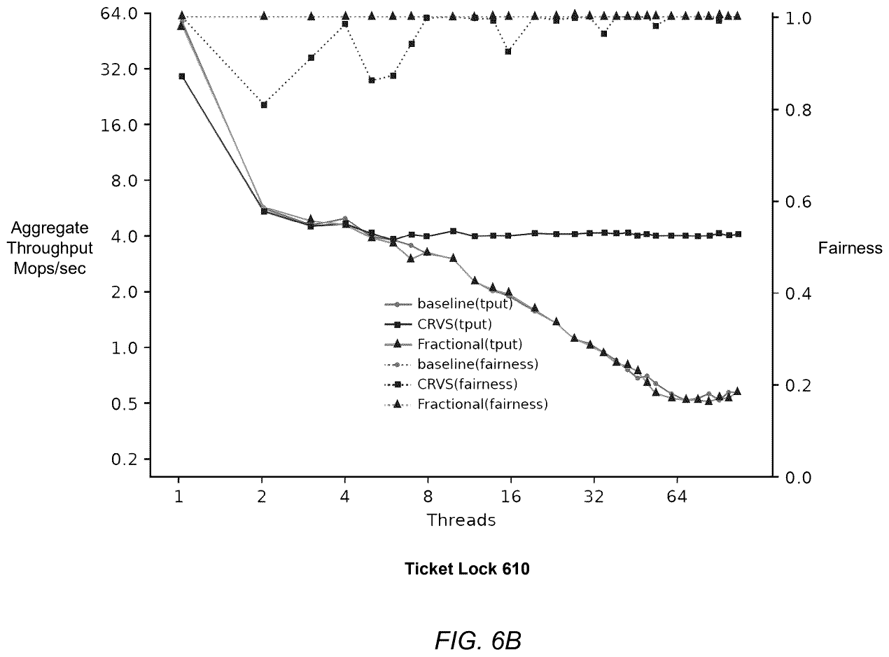

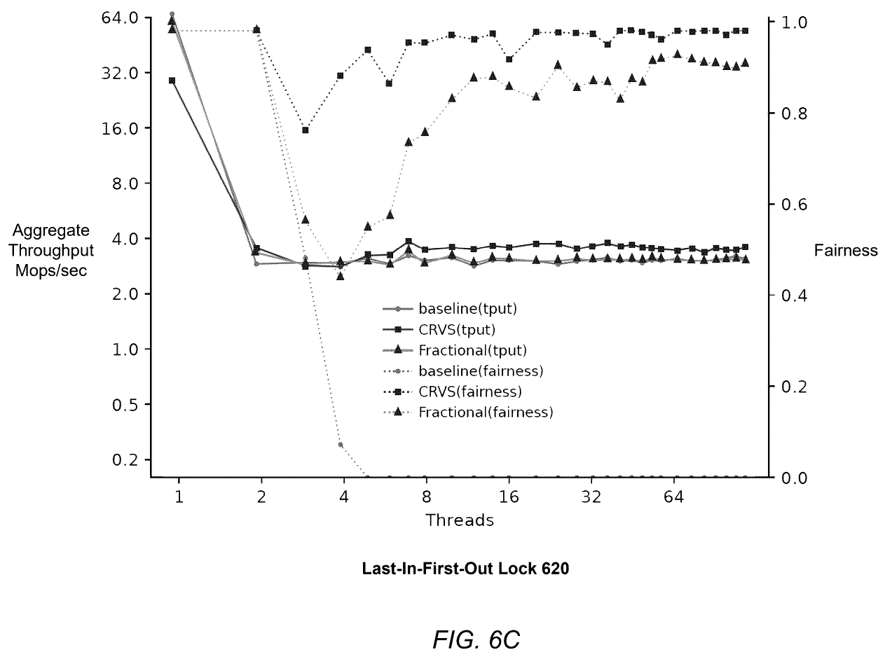

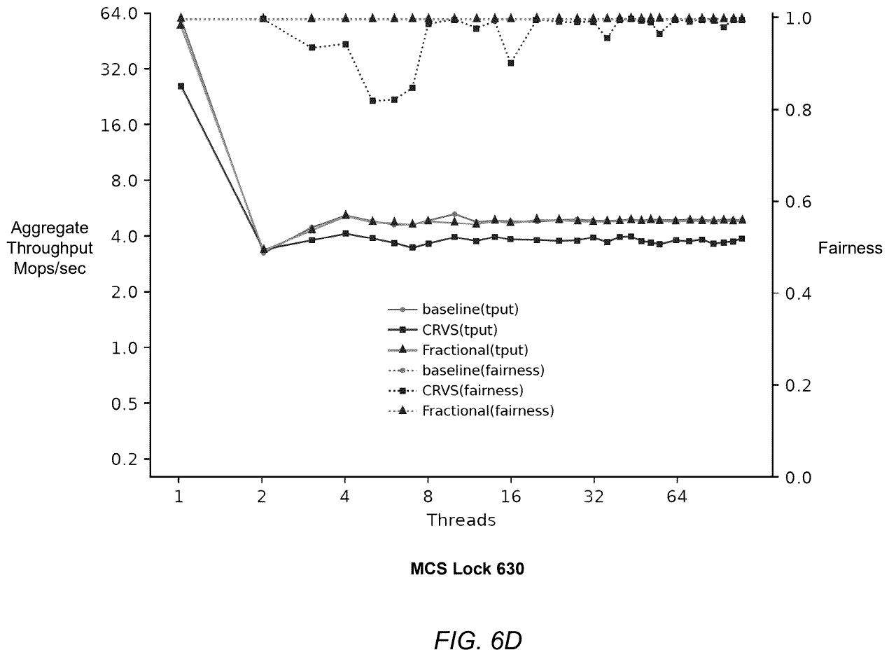

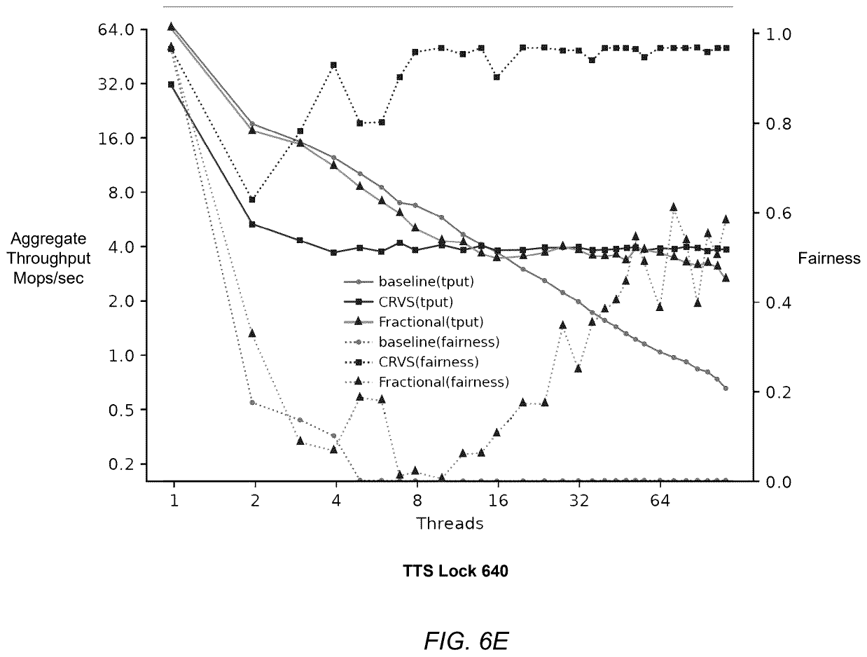

FIGS. 6A-6E show data collected on an ARMv8 Ampere Altra Max NeoVerse-N1 system with 128 processors on a single socket executing an embodiment of a scalable fairness-enhancing wrapper function, such as shown in FIGS. 3A-3D, wrapping various lock implementations. FIG. 6A is a graph illustrating throughput and fairness of a reciprocating lock accessed through a fairness-enhancing wrapper function according to at least one embodiment. FIG. 6B is a graph illustrating throughput and fairness of a ticket lock accessed through a fairness-enhancing wrapper function according to at least one embodiment. FIG. 6C is a graph illustrating throughput and fairness of a Last-In-First-Out lock accessed through a fairness-enhancing wrapper function according to at least one embodiment. FIG. 6D is a graph illustrating throughput and fairness of an MCS lock accessed through a fairness-enhancing wrapper function according to at least one embodiment. FIG. 6E is a graph illustrating throughput and fairness of a test-and-set lock accessed through a fairness-enhancing wrapper function according to at least one embodiment.

The test system used Ubuntu 24.04. All code was compiled using the -mno-outline-atomics-march=armv8.2-a+lse flags in order to allow direct use of modern atomic exchange, CAS and fetch-and-add instructions instead of the legacy LL-SC (load-locked store-conditional) forms thereof. Factory-provided system defaults were used in all cases. In all cases default free-range unbound threads were used, with no pinning of threads to processors. All lock busy-wait loops used the ARMv8 YIELD instruction. In the listings, the Pause operation a single ARMv8 YIELD instruction.

A simple locking microbenchmark, MutexBench, is used to examine the trade-off between fairness overheads and fairness efficacy. The MutexBench benchmark spawns T concurrent threads. Each thread loops as follows: acquire a central lock L; execute a critical section; release L; execute a non-critical section. The critical section advances a shared global std::mt19937 Mersenne Twister pseudo-random number generator (PRNG) one step, and the non-critical section is empty, subjecting the lock to extreme contention. (At just one thread, this configuration also constitutes a useful benchmark for uncontended latency).

At the end of a ten second measurement interval the benchmark reports the total number of aggregate iterations completed by all the threads. Also reported is a trivial measure of long-term fairness, expressed as the number of iterations completed by the thread that made the least progress in the interval divided by the number of iterations completed by the thread that made the most progress. A value of 1 is ideally fair and values toward 0 less so. The test implementations used the fairness-enhancing wrapper found in FIGS. 3A-3B with BypassLimit configured as ten.

Each data point is repeated 11 times, with independent runs, and reported the median in FIGS. 4A-4E. Each individual graph represents the results for a specific lock algorithm, described below. Within each graph, the X-axis reflects the number of concurrently executing threads contending for the lock. The left Y-axis indicates aggregate throughput the tally of all loops executed by all the threads in the measurement interval. The right Y-axis depicts fairness. Solid lines reflect throughput and dotted lines reflect fairness. Red lines are used for the baseline lock and blue for the baseline lock wrapped with the semaphore. Magenta lines reflect a variant—labeled Fractional in the legend—where arriving threads run a Bernoulli trial, and with a probably of 99/100, skip the capacitor. For clarity and to convey the maximum amount of information to allow a comparison of the algorithms, the throughput Y-axis and the X-axis are logarithmic.

The following lock algorithms were tested: MCS (FIG. 6D) is classic MCS; Ticket (FIG. 6B) is a classic Ticket Lock; TTS (FIG. 6E) is a simple polite test-and-test-and-set lock with no backoff; LIFO (FIG. 6C) is a simple lock that provides LIFO admission order; Recipro (FIG. 6A) is the Reciprocating Lock algorithm, which can manifest long-term fairness of up to 2X. Both MCS and Ticket are FIFO, and thus already provide ideal fairness. These are included in order to measure the overheads imposed by the capacitor. As noted, LIFO provides LIFO admission order and can be seen as maximally unfair. We included LIFO in order to show that the fairness technique is effective at providing long-term fairness even in the face of an intentionally adversarial lock. In general we find that the capacitor imposes a relatively modest throughput cost at low contention levels while demonstrating high efficacy in terms of imposing long-term fairness. The test-and-set lock is an interesting case as, beyond 9 threads, the capacitor improves both fairness and throughput.

Many platforms exhibit topological favoritism or, specifically, NUMA favoritism, where atomic operations that are either near (in the topology) the home node of the cache line or are near the cache that currently holds the line in modified state are more prone than far requesters to be successful and serviced in the near time. Perversely, test-and-set locks are NUMA friendly on such platforms in that they reduce lock migration by virtue of such architectural unfairness, offering improved performance compared to pure FIFO locks. Backoff mechanisms commonly used in test-and-set locks also exacerbate unfairness, as a waiting/thread that has backed off is less like to acquire the lock in unit time than a more recently arrived lock. Backoff also represents “dead time” and is not work-conserving, as it is possible, under varying load, that the last waiting thread is stalled in a long backoff period when it could otherwise acquire the lock and drive progress. Wrapping such an unfair test-and-set lock with a capacitor acts to reduce unfairness arising from the factors mentioned above.

In at least one embodiment, a classic semaphore may be used as a wrapping function as opposed to the fairness technique as shown above in FIGS. 2-6. Such a semaphore would indeed restrict concurrency on the interior lock but it does not provide any form of bounded bypass guarantee. For example, suppose a bypass limit B to be 10 and there are 20 threads circulating over the contended lock. One thread, T (or small set of threads) might be admitted by the semaphore, but then be continually bypassed by a stream later arriving threads, resulting in long-term unfairness and starvation. Using the capacitor, as the number of threads in a platoon decays down to just 1, a remaining thread, assuming it was being interfered with and obstructed by other threads in that its platoon, will eventually become the sole remaining member of the platoon competing for the inner lock, and will then gain ownership and make progress. If we set the platoon size B to just one, then execution devolves to simple locking where all waiting is done via the semaphore. This degenerate configuration, while benign, is not particularly useful.

As noted above, the semaphore activities in the capacitor impose a performance cost at low contention levels. The impact can be observed at low contention with very short critical sections and high arrival rates. In this operating regime the semaphore is usually passive and threads do now tend to wait within the semaphore. That is, if there is no contention on the inner lock, then the capacitor provides no benefits. But the semaphore operations serve to increase the path length, adding latency. We now offer a number of techniques that can mitigate that cost or overhead.

On arrival, in the lock( ) operation, threads run a simple randomized Bernoulli trial. The probability of success or failure, P, constitutes a tunable “knob”. On success, control may be sent through the semaphore in the usual fashion for capacitors. On failure, however, we skip the semaphore and just divert control to directly acquire the inner lock. In that case, the subsequent corresponding unlock( ) also skips the capacitor departure phase. This approach reduces the overhead yet still impose long-term statistical admission fairness, although the short-term bypass bounds are no longer in place. The value of P reflects a trade-off between cost and the efficacy and time-frame of long-term fairness. This technique may be known as fractional bypass and is effective in acting to reduce long-term statistical admission fairness.

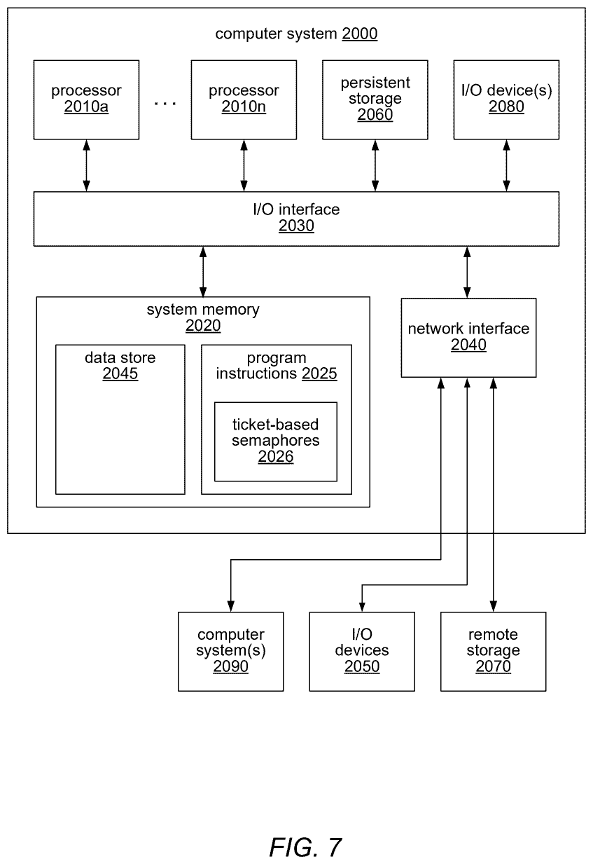

FIGS. 7A-7E show the result of one form of fractional bypass. Contention on the inner lock may be detected or predicted, then the semaphore only activated on arrival and departure paths under contention, skipping the semaphore when there is no contention, and the capacitor construct does not serve to impose ordering or provide any value. That is, the semaphore may be avoided when it is not needed and provides no benefit.

The relative cost (degradation compared to baseline) will be highest with very short critical sections and high arrival rates. Thus, to illustrate the operation of capacitor in the most challenging environment, the benchmark of FIGS. 7A-7E is configured with a very short critical section and empty noncritical section.

If scalability of the semaphore becomes a concern, multilane pattern may be applied to diffuse contention over a set of lanes, which each lane contains a semaphore. This preserves the bounded bypass property. In some embodiments, lanes may be chosen at random, which abrogates the bounded bypass property, but still provides long-term statistical admission fairness.

Threads blocked on the semaphore are engaged in long-term waiting while those waiting on the inner lock—having passed the semaphore—engage in short-term waiting. All threads within a platoon will be able to gain the inner lock before any threads waiting on the semaphore are able to acquire the inner lock. Under contention, the number of threads in a platoon, currently executing the arrive-depart window, exhibits a sawtooth wave form. Initially B are allowed to pass the semaphore and compete for the inner lock. As those threads gain ownership and depart, the number of threads competing for the inner lock decays toward 0, at which point a new platoon is ultimately enabled.

The TWA semaphore construct benefits from having wait-free constant-time arrival and release operations. Critically, it also provides FIFO FCFS admission order which is required to provide bounded bypass progress guarantees for the capacitor.

The composite lock is subject to two-stage waiting. Even if the semaphore has constant-time wait-free arrival and departure steps, and the inner lock similarly provides constant-time wait-free paths, we observe that the composite lock does not provide a wait-free arrival step because of the potential for two-stage waiting, where a thread might need to wait twice in one acquisition episode, for the capacitor (the capacitor's semaphore), and then once again for the inner lock.

Given I threads circulating, competing for a composite lock, and I<B. In this case threads can recirculate and re-arrive before the semaphore credits for a platoon episode are depleted and the capacitor closes. That is, in this circumstance, a thread may be able to enter and leave a given platoon “episode” multiple times. Some “fast” threads might bypass and overtake other threads in the same platoon. Such overtaking is bounded, however. Say B=8 and we also have 2 active circulating thread that have passed the semaphore. One of the 2 threads, T1, is “fast” and the other, T2 is“slow” in that it passes the capacitor's arrive operator but then stalls before being able to acquire the inner lock Fast thread T1 may then lap or overtake slow T2 another 6 times before the capacitor becomes depleted and closes, and the fast thread T1 then needs to wait in the arrive step Eventually the slow thread T2 will pass the inner lock, call depart, and the capacitor will re-open. In the very worst case and under sustained and equal offered load, a given thread can make at most B-1 times more progress (admissions to the critical section) than another given thread. As such, our approach imposes a useful bound on long-term unfairness and also avoids short-term starvation.

While all cases of bypass are intra-platoon, when T<B, if a thread departs and then comes back through the still open semaphore, it can rejoin the same platoon and re-compete for the inner lock. In practice, when I<B, the semaphore tends to say passive and threads rarely block. When T>=B, and assuming sustained arrival rates and offered load, the approach provides 1-bounded-bypass, as any “fast” thread will depart, re-arrive, and then block, joining the next platoon, and inhibiting bypass.

Any unfair lock or other synchronization operation may be wrapped with a capacitor. The composition technique is agnostic as to the properties or design of the inner operation. We note that if the inner operation happens to be NUMA-aware, then the wrapped lock will also be NUMA-aware.

If an inner lock uses global spinning, where multiple waiting threads busy—wait on the same memory location, then lock inner lock will usually suffer from scalability collapse at high contention—with many waiting threads and a high arrival rate. Ticket locks and test-and-set are classic examples of locks that use global spinning. When wrapped with a capacitor, however, such locks may become scalable at high contention levels, as we have restricted the degree of global spinning. As such, wrapping test-and-set locks can provide both improved fairness and better throughput.

As expected, locks that avoid global spinning, such as MCS, do not gain any performance benefit from wrapping. Similarly, as MCS is already FIFO, so wrapping provides not fairness benefits. In the case of Reciprocating Locks, wrapping mitigates the long-term unfairness arising from the reciprocating admission schedule.

Some of the mechanisms described herein may be provided as a computer program product, or software, that may include a non-transitory, computer-readable storage medium having stored thereon instructions which may be used to program a computer system 2000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

Any of various computer systems may be configured to implement processes associated with a technique for multi-region, multi-primary data store replication as discussed with regard to the various figures above. FIG. 7 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 7 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for ticket-based semaphores as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 7 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A system, comprising:
at least one processor;
a memory, comprising program instructions that when executed by the at least one processor cause the at least one processor to implement a synchronization wrapper configured to:
control admission, for individual threads of a plurality of threads, to a synchronization primitive, wherein to control admission, the synchronization wrapper is configured to:
allow entry to the synchronization primitive responsive to determining that a blocking indicator is in a cleared state, wherein to allow entry, the synchronization wrapper is configured to set the blocking indicator to a blocked state responsive to determining that a number of threads allowed entry to the synchronization primitive meets or exceeds a maximum threshold number of threads;
block entry to the synchronization primitive responsive to determining that the blocking indicator is in the blocked state; and
set the blocking indicator to the cleared state responsive to determining that the number of threads allowed entry to the synchronization primitive is at or below a minimum threshold number of threads.

2. The system of claim 1, wherein the minimum threshold number of threads is zero.

3. The system of claim 1, wherein the maximum threshold number of threads is determined according to a fairness constraint.

4. The system of claim 1, wherein the synchronization primitive is a test-and-set lock exhibiting long-term unfairness under load.

5. The system of claim 1, wherein the synchronization primitive is implemented in an external library.

6. The system of claim 1, wherein the synchronization wrapper comprises a wait table further comprising a plurality of buckets, and wherein a number of the plurality of buckets is determined according to a number of processors of the system.

7. The system of claim 6, wherein to allow entry to the synchronization primitive the synchronization wrapper is configured to access a current bucket of the wait table, and wherein to set the blocking indicator to the cleared state the synchronization wrapper is configured to advance the current bucket from a first bucket of the plurality of buckets to a second bucket of the plurality of buckets different from the first bucket.

8. A computer-implemented method, comprising:
controlling admission, by a synchronization wrapper for individual threads of a plurality of threads, to a synchronization primitive, comprising:
allowing entry to the synchronization primitive responsive to determining that a blocking indicator is in a cleared state, the allowing comprising setting the blocking indicator to a blocked state responsive to determining that a number of threads allowed entry to the synchronization primitive meets or exceeds a maximum threshold number of threads;
blocking entry to the synchronization primitive responsive to determining that the blocking indicator is in the blocked state; and
setting the blocking indicator to the cleared state responsive to determining that the number of threads allowed entry to the synchronization primitive is at or below a minimum threshold number of threads.

9. The computer-implemented method of claim 8, wherein the minimum threshold number of threads is zero.

10. The computer-implemented method of claim 8, wherein the maximum threshold number of threads is determined according to a fairness constraint.

11. The computer-implemented method of claim 8, wherein the synchronization primitive is a test-and-set lock exhibiting long-term unfairness under load.

12. The computer-implemented method of claim 8, wherein the synchronization primitive is implemented in an external library.

13. The computer-implemented method of claim 8, wherein the synchronization wrapper comprises a wait table further comprising a plurality of buckets, and wherein a number of the plurality of buckets is determined according to a number of processors.

14. The computer-implemented method of claim 13, wherein allowing entry to the synchronization primitive comprises accessing a current bucket of the wait table, and wherein setting the blocking indicator to the cleared state comprises advancing the current bucket from a first bucket of the plurality of buckets to a second bucket of the plurality of buckets different from the first bucket.

15. One or more non-transitory, computer-readable storage media, storing program instructions that when executed on or across one or more processors cause the one or more processors to implement a synchronization wrapper to perform:
controlling admission, for individual threads of a plurality of threads, to a synchronization primitive, comprising:
allowing entry to the synchronization primitive responsive to determining that a blocking indicator is in a cleared state, the allowing comprising setting the blocking indicator to a blocked state responsive to determining that a number of threads allowed entry to the synchronization primitive meets or exceeds a maximum threshold number of threads;
blocking entry to the synchronization primitive responsive to determining that the blocking indicator is in the blocked state; and
setting the blocking indicator to the cleared state responsive to determining that the number of threads allowed entry to the synchronization primitive is at or below a minimum threshold number of threads.

16. The one or more non-transitory, computer-readable storage media of claim 15, wherein the minimum threshold number of threads is zero.

17. The one or more non-transitory, computer-readable storage media of claim 15, wherein the maximum threshold number of threads is determined according to a fairness constraint.

18. The one or more non-transitory, computer-readable storage media of claim 15, wherein the synchronization primitive is a test-and-set lock exhibiting long-term unfairness under load.

19. The one or more non-transitory, computer-readable storage media of claim 15, wherein the synchronization primitive is implemented in an external library.

20. The one or more non-transitory, computer-readable storage media of claim 15, wherein the synchronization wrapper comprises a wait table further comprising a plurality of buckets, and wherein a number of the plurality of buckets is determined according to a number of processors of the one or more processors, wherein allowing entry to the synchronization primitive comprises accessing a current bucket of the wait table, and wherein setting the blocking indicator to the cleared state comprises advancing the current bucket from a first bucket of the plurality of buckets to a second bucket of the plurality of buckets different from the first bucket.
